(19) United States
(12) Patent Application Publication
(10) Pub. No.: US 2013/0045300 A1
(43) Pub. Date: Feb. 21, 2013

(54) PROCESS FOR CONTINUING BARREL AGING OF ALCOHOL FOLLOWING BOTTLING THEREOF

(71) Applicant: Robert George ROBILLARD, Chester, NH (US)

(72) Inventor: Robert George ROBILLARD, Chester, NH (US)

(21) Appl. No.: 13/426,964

(22) Filed: Mar. 22, 2012

Related U.S. Application Data
(60) Provisional application No. 61/524,848, filed on Aug. 18, 2011.

(51) Int. Cl. C12H 1/22

(52) U.S. Cl. 426/11

(57) ABSTRACT

A method of aging of alcohol following bottling of the alcohol. The method comprising the steps of fermenting a mash and then distilling the mash to form a concentrated alcohol and temporarily storing the concentrated alcohol within a wooden container to barrel age the concentrated alcohol. During the bottling process, either before the alcohol is added to the individual bottling container or once the alcohol is added individual bottling container, at least one of wood chips, wood shavings and/or wood pieces are added to the interior cavity of the individual bottling container so that the alcohol, once bottled within the individual bottling container, can intimately mix and engage with the wood chips, wood shavings and/or wood pieces and continue the barrel aging process following bottling of the alcohol up until the point in time at which the alcohol is consumed.

### FIELD OF THE INVENTION

The present invention relates to a process for continuing the barrel aging process of alcohol, such as whiskey, rum, etc., following bottling of the alcohol so that the alcohol continues to the barrel aging process, following bottling, and thereby continues to improve the flavor of the alcohol.

### BACKGROUND OF THE INVENTION

As is well known in the art, the distilling process for certain alcohols, such as whiskey and rum for example, typically involves storing the alcohol within a wooden container or barrel which is typically manufactured from oak or maple, for example, which is typically a 53 gallon container. While the alcohol is stored in the wooden oak or maple container or barrel, the alcohol is “barrel aged” by absorbing flavor from the wooden oak or maple container or barrel.

Expensive whiskeys and rums, for example, are aged for a number of years prior to bottling the alcohol. That is, many finer whiskeys and rums will be aged within a wooden container or barrel for at least 8 years and more preferably about 17 years before being bottled within a conventional glass or plastic bottle or container. While the alcohol is contained within the wooden container or barrel, the alcohol slowly and gradually absorbs some of the flavor from the wooden container or barrel as the alcohol gradually ages. The longer the alcohol remains within the wooden container or barrel, the longer aging process and generally the finer the quality of the alcohol and, correspondingly, the more expensive the alcohol.

As is well known in the art, the instant that the alcohol is removed from the wooden container or barrel and commences the bottling process, the barrel aging process for the alcohol immediately ceases. That is, as soon as the alcohol is removed from the wooden container or barrel and bottled within a glass or plastic container, for example, the aging process immediately discontinues and the flavor of the alcohol does not improve any further regardless of how long the alcohol remains stored within the glass or the plastic container.

### SUMMARY OF THE INVENTION

Wherefore, it is an object of the present invention to overcome the above mentioned shortcomings and drawbacks associated with the bottling processes of the prior art and continue the aging process up until the point in time that the alcohol is actually consumed by a consumer.

Another object of the present invention is to provide a bottling process in which alcohol, following bottling within a plastic container or a glass bottle, continues to undergo the aging process by continuing to absorb flavor from the wood contained therein, in the form of at least one of wooden chip(s), wood shaving(s), wooden piece(s), wooden cube(s), etc., so that the flavor of the alcohol continues to improve, following the bottling process, as long as the alcohol is able to contact or interact with the wooden chip(s), wood shaving(s), wooden piece(s), wooden cube(s), etc., contained within the glass or the plastic container.

A further object of the present invention is to provide an exposed surface area of between 18 cm² and 1680 cm² square inches, more typically between about 72 cm² and 168 cm² square inches of wood within each 0.75 ml or 1.75 ml individual container of alcohol so that the wood contained therein continues the barrel aging process of the alcohol and thereby continues to improve the flavor of the alcohol, following bottling thereof, up until the point in time when the alcohol is actually consumed by the consumer.

Yet another object of the present invention is to place a desired quantity or exposed surface area of at least one of wood chip(s), wood shaving(s), wood cube(s) and/or wood piece(s) within an interior cavity of the plastic container or glass bottle, either prior to filling the plastic container or the glass bottle with the alcohol or after the alcohol filling process but prior to capping or sealing the plastic container or glass bottle, so that at least one of the wood chip(s), wood shaving(s), the wood cube(s) and/or wood piece(s) is in intimate contact with the alcohol contained within the plastic container with a glass bottle so that the barrel aging process of the alcohol continues, following bottling, up until the point in time when the alcohol is finally consumed.

A still further object of the present invention is to enclose at least one of wood chip(s), wood shaving(s), wood cube(s) and/or wood piece(s) within a small permeable pouch, e.g., a pouch made of cheese cloth for example, which is located within the plastic container or the glass bottle, either prior to filling with the alcohol or after filling but before capping or sealing, so that the alcohol can intimately contact and thoroughly intermix with the at least one of the wood chip(s), the wood shaving(s), the wood cube(s) and/or the wood piece(s) and absorb additional flavor therefrom while the pouch captively retains the at least one of the wood chip(s), the wood shaving(s), wood cube(s) and/or the wood piece(s) so that they are not inadvertently allowed to flow out of the plastic container or glass bottle and be consumed by the consumer.

Another object of the invention is to provide a sufficient amount or surface area of the wood chip(s), the wood shaving(s), wood cube(s) and/or the wood piece(s) within each plastic container or glass bottle so that the alcohol can continue the barrel aging process for at least three years, and more preferably continue the barrel aging process for between 5 and 17 years or more and thereby continue to improved the flavor and the taste of the alcohol at minimal cost and effort.

A still further object of the invention provide an increased amount or exposed surface area of the wood chip(s), the wood shaving(s), wood cube(s) and/or the wood piece(s) within each plastic container or glass bottle so as to accelerate barrel aging process by at least 50%, or possibly accelerate the barrel aging process by between about 100% to as much as about 400% or more. That is, by placing twice as much exposed surface area (200%) within each plastic container or glass bottle, alcohol which is aged for only one year can approach the flavor of alcohol which is been aged for two years, by placing four times as much exposed surface area (400%) within each plastic container or glass bottle, alcohol which is aged with that container for only one year can approach the flavor of alcohol which is been aged for 4 years, etc.

Yet another object of the present invention is to provide at least one relatively thin wood chip(s), wood shaving(s), wood cube(s) and/or wood piece(s) and also provide at least one relatively thick wood chip(s), wood shaving(s), wood cube(s) and/or wood piece(s) within each plastic container or glass bottle in which the relatively thin wood chip(s), wood shaving(s), wood cube(s) and/or wood piece(s) provides an accelerated barrel aging process while the relatively thick wood chip(s), wood shaving(s) and/or wood piece(s) provide a slower, normal barrel aging process.

A still further object of the invention is to increase the ratio of the exposed surface area of the wood to volume of alcohol to accelerate the transfer of the flavoring from the wood to the alcohol over a shorter barrel aging duration of time.

Yet another object of the invention is to, after bottling the alcohol and storage, to permit replacement of the original wood chip(s), wood shaving(s), wood cube(s) and/or wood piece(s) with a new batch of fresh of either the same of possibly a different type of wood chip(s), wood shaving(s), wood cube(s) and/or wood piece(s).

A still further object of the invention is to install a strainer, a pouring spout or some other large particle flow inhibitor or restrictor over or insert into the inlet/outlet opening of the plastic container or glass bottle, prior to the capping or sealing process, so as to prevent the flow of the pouch, the wood chip(s), wood shaving(s), wood cube(s) and/or wood piece(s) from flowing out of the plastic or glass bottle or container when a consumer is pouring a drink.

Yet another object of the invention is to store each plastic or glass container or bottle under suitable conditions, following the capping or sealing process, so as to replicate the normal aging process and/or assist with preserving or accelerating the alcohol aging process.

The present invention also relates to a method of aging of alcohol following bottling of the alcohol, the method comprising the steps of: forming a mash and allowing the mash to ferment; distilling the mash to form an alcohol concentrate; storing the alcohol concentrate within a wooden container to commence barrel aging of the alcohol concentrate for a desired duration of time; following the aging process, diluting the alcohol concentrate and bottling the diluted alcohol concentrate within an individual container; and adding at least one of a wood chip, a wood shaving and a wood piece into an interior cavity of the individual container so that the diluted alcohol, once bottled within the individual container, can intimately mix with the at least one of a wood chip, a wood shaving and a wood piece and continue the barrel aging process following bottling of the diluted alcohol.

### BRIEF DESCRIPTION OF THE DRAWINGS

The invention will now be described, by way of example, with reference to the accompanying drawings in which:

FIG. 1 is a diagrammatic drawing showing a conventional wooden barrel for preforming a barreling aging process of alcohol;

FIG. 2 is a diagrammatic drawing showing the basic steps involved in conventional fermentation and distilling of alcohol as well as bottling thereof; and

FIG. 3 is a diagrammatic drawing showing inventive aspect of the present invention.

### DETAILED DESCRIPTION OF THE INVENTION

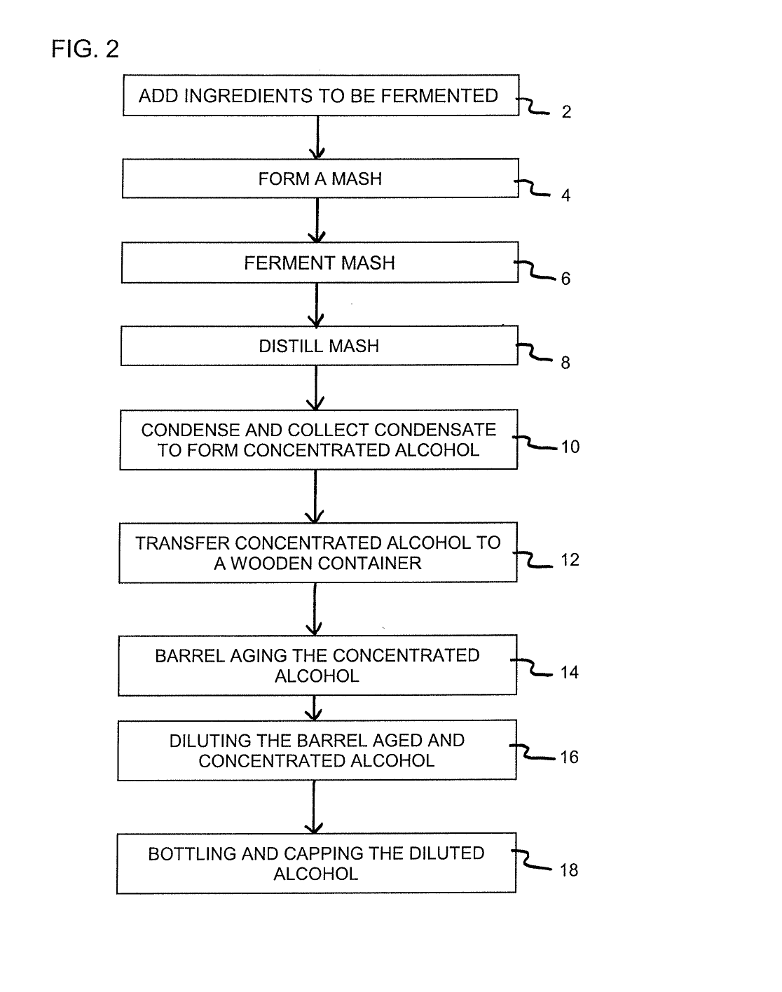

Turning first to FIG. 2, a brief description concerning the various process steps for fermenting and distilling alcohol will now be briefly discussed. As can be seen in this Figure, a conventional fermentation and/or distilling process is diagrammatically shown. That is, the ingredients including the yeast as well as desired sugar to be fermented (e.g., maple sugar, rye, corn, etc.) are typically placed, at step 2, in a larger vat or some other suitable container to form a mash, as generally indicated at step 4. The mash is then allowed to ferment, at step 6, until the mash typically has an alcohol content of about 16%.

Next, this mash is then distilled, as diagrammatically shown in step 8, and the condensate, obtained during the distilling process, is then collected to form a concentrated alcohol, as diagrammatically shown at step 10. The concentrated alcohol typically has an alcohol content of between 60% (i.e., 120 Proof) to 65% (i.e., 130 Proof).

The concentrated alcohol is then transferred to a wooden storage container or barrel, at step 12, where the concentrated alcohol will undergo a natural barrel aging process. Once contained within the large wooden storage container, drum or barrel, the alcohol is stored for desired duration of time, e.g., from a number of months to many years typically somewhere between 3 and 8 years, where the concentrated alcohol will then undergo the barrel aging process, as diagrammatically indicated in step 14. During the barrel aging process, the flavor of the wooden container, i.e., the flavor from either the oak or the maple container or barrel, is gradually transferred to the alcohol over time. As is well known in the industry, the longer the concentrated alcohol is permitted age, generally the better the quality and the flavor of the concentrated alcohol. Moreover, as it is more costly to age concentrated alcohol, distillers can typically charge higher price which reflects the higher manufacturing and production costs associated with longer barrel aging process of the concentrated alcohol.

As noted above in the Background of the Invention section, however, as soon as the concentrated alcohol is transferred from the wooden storage container or barrel to some other container and commences the bottling process, the alcohol is suitably diluted, at step 16, the transferred and diluted alcohol is no longer in contact with wood storage container or barrel and thus cannot continue to absorb any flavor from the wooden storage container or barrel. That is, the barrel aging process discontinues and the diluted alcohol is then bottled in a conventional manner, at step 20.

It is to be appreciated that in many applications, the concentrated alcohol is diluted with water and/or some other additive, such as a flavoring additive or a color additive, for example, prior to bottling the alcohol within a bottling container. As with all prior art distilling processes, as soon as the alcohol is transferred from the wooden storage container or barrel, the alcohol immediately discontinues any further aging process and thereafter the flavor of the alcohol does not continue to improve or be enhanced regardless of how long the alcohol remains stored within a plastic container or a glass bottle, for example.

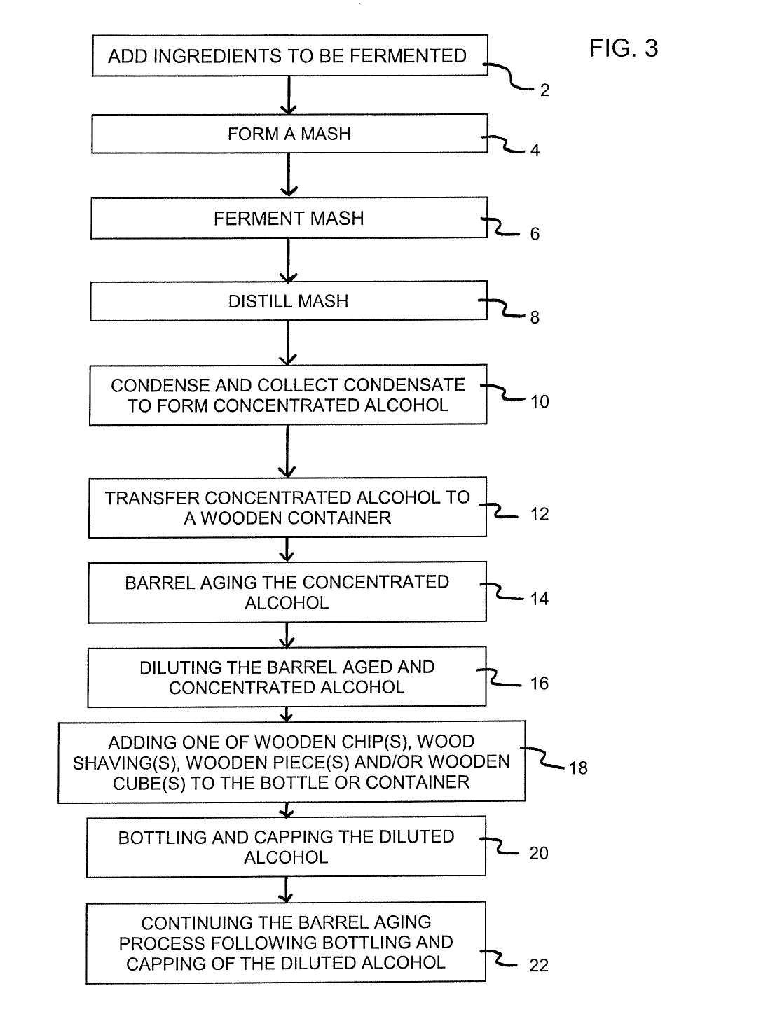

In order to overcome this deficiency, the present invention provides, as shown in FIG. 3, additional steps. That is, FIG. 3 generally includes steps 2-14 discussed above as well as the diluting step of step 16. The present invention, however, also includes the addition step, at step 18, of adding at least one of wood chip(s), wood shaving(s), wood cube(s) and/or wood piece(s) into the interior cavity of each individual bottling container, e.g., each 0.375 ml, 0.75 ml, 1.75 ml or any other desired or suitably sized plastic bottle, glass bottle, metal container, etc., either prior to each individual container being filled with the alcohol or after the filling process but prior to capping or sealing each individual container closed with a conventional cap or threaded cover, provided during bottling step 20. It is to be appreciated that a pouring spout, a strainer, or some other pouring device may be applied or otherwise affixed to or inserted into the inlet/outlet opening of the bottle or the container to prevent the wood from inadvertently flowing out of the bottle or the container when a consumer is pouring a drink.

Lastly, the process continues, at step 22, during which the diluted alcohol is now able to intimately contact and interact with the added wood chip(s), wood shaving(s), wood cube(s) and/or wood piece(s) and thereafter continues the aging process, described above, up until the point in time at which all of the alcohol is actually poured from the bottle or the container by the consumer for consumption.

According to the present invention, it is desirable to add a sufficient amount or surface area of at least one of wood chip(s), wood shaving(s), wood cube(s) and/or wood piece(s) into the interior cavity of each individual bottling container so that the alcohol, once contained therein, can intimately contact with the added wood chip(s), wood shaving(s), wood cube(s) and/or wood piece(s) contained therein and thereby continue the aging process for so long as the alcohol remains in intimate contact with the wood chip(s), the wood shaving(s), wood cube(s) and/or the wood piece(s) contained within the individual bottling container. Accordingly, the aging process will continue at the bottling plant, following bottling of the alcohol, during storage of the bottled alcohol at the bottling facility, during shipment of the bottled alcohol from the bottle facility to a storage facility, during shipment of the bottled alcohol to a point of sale, while the bottled alcohol is resting on the shelf at the point of sale, after purchase of the bottled alcohol by the consumer and up until the time when the alcohol is finally consumed by the consumer or his/her friends. That is, the flavor of the alcohol continues aging, over of time, up until the time of that the entire contents of the bottled alcohol is eventually consumed by the consumer.

It is to be appreciated that the larger the bottling container, the greater the quantity or exposed surface area of the wood chip(s), the wood shaving(s), wood cube(s) and/or the wood piece(s) to be added thereto to ensure that the alcohol continues the desired aging process. For example, for a 750 ml bottling container, e.g., either a plastic container or a glass bottle, an exposed surface area of between about 36 cm² and 576 cm², more preferably between about 72 cm² and 288 cm² of wood chip(s), wood shaving(s), wood cube(s) and/or wood piece(s) are added to the interior cavity of the individual bottling container. This amount of wood chip(s), wood shaving(s), wood cube(s) and/or wood piece(s) ensures that the alcohol is still able to continue the natural barrel aging process so that in the event that the alcohol is not consumed for five years, for example, the alcohol will have a similar or equivalent flavor to alcohol which has been aged five years within a wooden storage container or barrel prior to bottling.

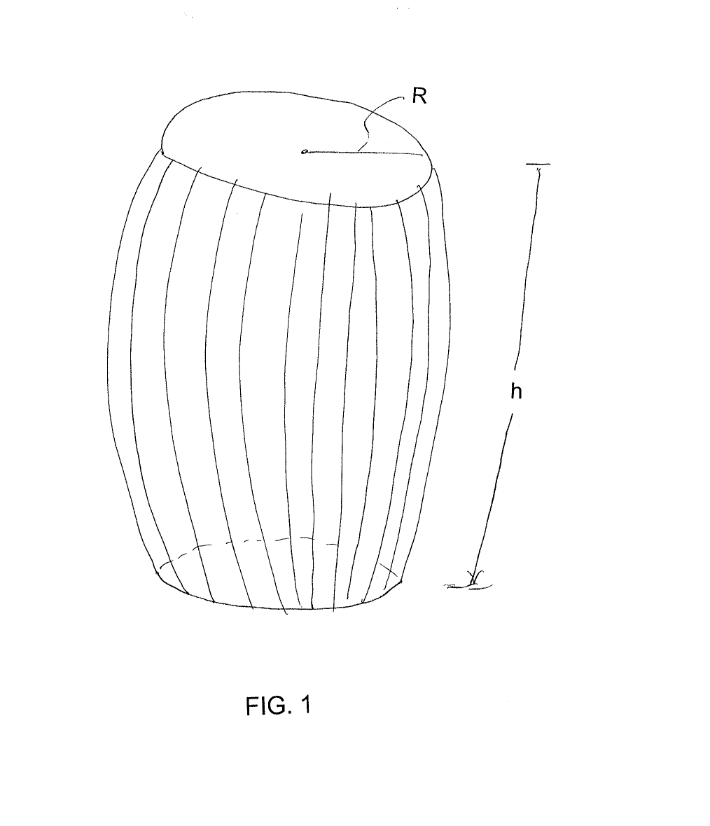

As is conventional and well known in the prior art, typical dimensions of a wooden container or barrel, diagrammatically shown in FIG. 1, in inches are:

Rad 1 (r₁)=10.5″

Rad 2 (r₂)=13.0″

Height (h)=36″

The above dimensions are the outer dimensions. Since a barrel typically has a thickness of about 2.4″, that amount is subtracted from the above dimensions which results in the following internal dimension values for the wooden container or barrel:

Rad 1(r₁)=9.3″(subtracting 1.2″)

Rad 2(r₂)=11.8″ (subtracting 1.2″)

Height(h)=33.6″ (subtracting 2.4″)

The volume of the amount of whisky or alcohol that is typically contained within that wooden container or barrel is 53 gallons (i.e., 200,627 cm³). In approximating the internal surface area of the wooden container or barrel, the following assumption is made, namely, it is assumed that the wooden container or barrel has a generally cylindrical shape with appropriate changes in the dimensions, e.g., a cylinder with a radius of 10.3″ (a value between 9.3″ and 11.8″ which are the minimum and maximum radiuses of the wooden container or barrel). A value of 10.3″ is selected because, with this radius, the wooden container or barrel has an internal volume of approximately 53 gallons. The relevant calculation is as follows:

Volume of the cylinder=πr² h

Where, r=10.3″, h=33.6″ and π=3.14

The surface area of the cylinder, which approximates the internal surface area of the wooden container or barrel, is:

Cylindrical surface area=2π r²+2π r h

Where, r=10.3″, h=33.6″ and π=3.14

With these values, the calculated internal surface area of the wooden container or barrel is approximately 3014.12 square inches (19,445 cm²).

Assuming that the wood particle is in the form of a wood cube (i.e., the width, the height and the length of the wood cube are all generally uniform and equal and thus about 1.2 cm each) and since a wood cube has 6 exposed surfaces, the total surface area of the wood cube is:

TSA=6a².

Thus, the total surface area (TSA) of the cube=6*(1.2 cm)²=8.64 cm².

In order to determine the amount, or exposed surface area, of the wood particles to be added in order to continue the normal aging of the alcohol at generally the same rate as the conventional barrel aging process, based upon the above determined value, the following calculation is employed:

200,627 cm³ of alcohol is flavored by=19,445 cm² surface area of the barrel

Thus, in order to determine the surface area required to continue the typical or normal aging process (SACTAP) for a 750 ml container (750 cm³), the following formula is employed:

SACTAP=19,445 cm²*750 cm³/200,627 cm³

or

SACTAP=72 cm²

That is, a surface area of 72 cm² is equivalent total exposed surface area of the wood cubes would need to provide in order to continue the normal or typical aging process for the alcohol contained within a 750 ml container. In order to determine the amount of wood cube(s), the following formula is employed:

72 cm²(required surface area of wood particle(s))=x*8.64 cm²

Where x is the number of wood cubes and 8.64 cm² is the total surface area of each average single wood cube.

72 cm²(required surface area of wood particle(s))/8.64 cm²=x(number of wood cubes)

8.33=x(number of wood cubes).

Using a similar calculation for 1.75 L container of alcohol (i.e., 1750 ml), approximately 20 wood cubes would be required in order to continue the normal or typical barrel aging process for a 1.750 ml container.

As noted above, the typical ratio of the surface area of the barrel to the alcohol contained within the barrel is:

19,445 cm²:200,627 cm³ or a ratio of about 1:10.32.

If the above ratio of the surface area of the added wood particles to the alcohol contained within the bottle or contain is maintained at about 1:10, then the aging process will continued at about the same rate. Conversely, if the ratio of the surface area of the added wood particles to the alcohol contained within the bottle or contain is increased to about 1:5 or 1:2.5, then the aging process with continued at an accelerated rate while if the ratio of the surface area of the added wood particles to the alcohol contained within the bottle or contain is decreased to about 1:15, then the aging process with continued at a slower rate.

It is to be appreciated that the thinner and/or smaller wood chip(s), wood shaving(s) and/or wood piece(s), e.g., the larger the surface area of the wood, generally the more rapid the aging process will occur. Conversely, the thicker and/or larger the wood chip(s), wood shaving(s) and/or wood piece(s), e.g., generally the smaller the exposed surface area of the wood, and generally the slower the barrel aging process will occur. Accordingly, for some applications it may be desirable to have only thinner and/or smaller wood chip(s), wood shaving(s), wood cube(s) and/or wood piece(s) while for other applications it may be desirable to have only thicker and/or larger wood chip(s), wood shaving(s), wood cube(s) and/or wood piece(s). For still for other applications, it may be desirable to have a combination of both types of wood, e.g., some thinner and/or smaller wood chip(s), wood shaving(s), wood cube(s) and/or wood piece(s) in combination with some thicker and/or larger wood chip(s), wood shaving(s), wood cube(s) and/or wood piece(s) or possibly wood chip(s), wood shaving(s), wood cube(s) and/or wood piece(s) of different types of wood or having different roast characteristics.

In the event that an accelerated barrel aging process is desired, an extra quantity, amount or exposed surface area of wood chip(s), wood shaving(s), wood cube(s) and/or wood piece(s) is added to the interior cavity of the individual bottling container than required for the normal or typical aging process for the alcohol. This additional extra quantity, amount or exposed surface area of wood chip(s), wood shaving(s), wood cube(s) and/or wood piece(s) provides additional surface area for the alcohol to contact and thereby generally facilitates acceleration of the aging process. For example, if twice the determined amount or exposed surface area of the wood chip(s), wood shaving(s), wood cube(s) and/or wood piece(s) is added to the interior cavity of the individual bottling container, the barrel aging process can occur twice as fast. Accordingly, if the alcohol was stored at the distillery for only one year by had twice the determined amount of wood chip(s), wood shaving(s), wood cube(s) and/or wood piece(s), the alcohol will typically have a flavor which corresponds to the flavor of alcohol that was barrel aged for two years. Correspondingly, if four times the determined amount of the wood chip(s), wood shaving(s), wood cube(s) and/or wood piece(s) is added to the interior cavity of the individual bottling container and that alcohol is stored at the distillery for only one year, the alcohol will typically have a flavor which corresponds to the flavor of alcohol that was barrel aged for four years, etc. Alternatively, if only half the determined amount of the wood chip(s), wood shaving(s), wood cube(s) and/or wood piece(s) is added to the interior cavity of the individual bottling container, the barrel aging process would typically only be half as fast. Accordingly, if the alcohol was stored at the distillery for only one year, the alcohol will typically have a flavor which corresponds to the flavor of alcohol that was barrel aged for only half a year.

It is to be appreciated by suitable selection of the desired quantity and surface area of the wood chip(s), wood shaving(s), wood cube(s) and/or wood piece(s) to be added to the interior cavity of the individual bottling container, it is relatively easy to control the bottle aging process and thereby achieve the desired flavor following bottling of the alcohol. The distiller can suitably mark each individual bottling container with the date on which the individual bottling container was bottled at the distillery and can also mark a container with a factor indicating the amount or exposed surface area of wood chip(s), wood shaving(s), wood cube(s) and/or wood piece(s) added to the interior cavity—either greater than, less than or equal to the determined amount for normal aging—so that the consumer can readily determine the anticipated further aging to be achieved by the added quantity or amount of wood chip(s), wood shaving(s), wood cube(s) and/or wood piece(s).

According to one embodiment of the invention, a single elongate dowel having a diameter of between ⅛ and ½ inch and a length of between 4 and 12 inches or so is inserted into the interior cavity of each individual bottling container to provide the barrel aging process. In yet another embodiment, an elongate extremely thin piece of wood having a length of between 2 and 8 inches, a width of between 4 and 15 inches and a thickness of between a few thousands of an inch and 1/16 of inch is inserted into the interior the interior cavity of each individual bottling container to provide the barrel aging process. Due to the relative thinness of this piece of material and the increased amount of surface area, the barrel aging process is significantly accelerated so that the flavor of the alcohol is greatly enhanced even for very short storage durations of bottle aging. It is to be appreciated that this very thin piece of wood could also function as a product label and be located within the interior cavity of the bottle and biased against the interior surface of the bottle or container, due to the inherent resiliency of this very thin piece of wood tending to return to a planar configuration. An outwardly facing surface of this very thin piece of wood can be marked with the trademark as well as other product and/or source information and be viewed by a consumer when considering purchase of the product. According to this embodiment, this very thin piece of wood has a dual function, namely, functions both as a product label as well as a flavor enhancer.

According to another embodiment, the wood chip(s), wood shaving(s), wood cube(s) and/or wood piece(s) may be completely removed from the individual container after a desired period of time, e.g., once the alcohol has been suitably flavored to meet the needs or liking of the consumer. For example, if after a desired period of time, the consumer may completely removed the originally added wood chip(s), wood shaving(s), wood cube(s) and/or wood piece(s) or possibly add a new batch of wood chip(s), wood shaving(s), wood cube(s) and/or wood piece(s) to the alcohol in order to continue the desired aging process or possibly alter the flavor by adding a different kind of wood, a different type or kind of roasted wood, etc.

In yet another embodiment, the ambient temperature in which the individual container is stored may be controlled so as to promote and/or optimize the aging process. For example, a temperature range between 35 and 75 degrees centigrade may be used to provide an environment suitable such optimized the aging process. Such temperature control has a tendency of also assisting with thermodynamically accelerating the aging process.

It is to be appreciated that the barrel aging process, as disclosed herein, is suitable for barrel aging of all types of alcohols and not particularly limited to either rum or whiskey. However, the present invention is particularly applicable to various kinds of whiskeys, for example, Canadian whiskey, Irish whiskey, American whiskey and Scotch whiskey.

One source for a supply of suitable wood chip(s), wood shaving(s), wood cube(s) and/or wood piece(s) is Crosby & Baker of Salt Lake City Utah. Crosby & Baker manufactures and markets a variety of different types of woods of different roasts types, e.g., light roast and dark roast, which are all suitable for use with the present invention and facilitate obtaining the desired alcohol flavoring during the aging process described herein.

In order to commence the aging process substantially immediately upon adding the desired wood chip(s), wood shaving(s), wood cube(s) and/or wood piece(s) to the container, the desired wood chip(s), wood shaving(s), wood cube(s) and/or wood piece(s) are first placed within a conventional vat, or some other container, and thereafter a desired quantity of the alcohol to be aged is added to the vat. Preferably the vat includes a stirring device, or some other conventional mixing or stirring apparatus, which facilitates intimate mixing and eventually complete saturation of the added wood chip(s), wood shaving(s), wood cube(s) and/or wood piece(s) with a small quantity of the alcohol to be aged (e.g., a few gallons or so). That is, preferably the wood chip(s), wood shaving(s), wood cube(s) and/or wood piece(s) are each completely and thoroughly saturated with a small quantity of the alcohol to be aged.

In order to ensure complete saturation of the wood chip(s), wood shaving(s), wood cube(s) and/or wood piece(s) with the alcohol to be aged, the wood chip(s), wood shaving(s), wood cube(s) and/or wood piece(s) are pre-soaked within the alcohol to be aged for a duration of time of between about one week to about two years, more preferably pre-soaked for a duration of time of between about one month to about one and a half years and most preferably pre-soaked for a duration of time of between about three months to about eight months. As a result of such pre-soaking, the pre-soaked wood chip(s), wood shaving(s), wood cube(s) and/or wood piece(s) are completely saturated and thus immediately able to commence the aging and/or the flavoring process for the alcohol to be aged as soon as both the pre-soaked wood chip(s), wood shaving(s), wood cube(s) and/or wood piece(s) and the alcohol to be aged are added to the individual container during the bottling process. It is to be appreciated that in the event that dry wood chip(s), wood shaving(s), wood cube(s) and/or wood piece(s) were instead added to the alcohol to be aged, such dry wood chip(s), wood shaving(s), wood cube(s) and/or wood piece(s) would first have to become saturated with the alcohol to be aged before the aging process could commence efficiently.

According to a still further modification of the present invention, the desired wood chip(s), wood shaving(s), wood cube(s) and/or wood piece(s) may alternatively be pre-soaked in a desired (e.g., red, white or rose) wine, a port, brandy, some other flavoring, a flavor enhancer, etc. As with the previous embodiment, preferably the desired wood chip(s), wood shaving(s), wood cube(s) and/or wood piece(s) are placed within a conventional vat and thereafter a desired quantity of the wine, port, brandy, other flavoring, flavor enhancer, etc., is add the vat. A stirring device, or some other conventional mixing or stirring apparatus, facilitates intimate mixing and eventually complete saturation of the added wood chip(s), wood shaving(s), wood cube(s) and/or wood piece(s) with the wine, port, brandy, other flavoring, flavor enhancer, etc. That is, preferably the wood chip(s), wood shaving(s), wood cube(s) and/or wood piece(s) are each completely and thoroughly saturated with the wine, port, brandy, other flavoring, flavor enhancer, etc. Such pre-soaked and flavored wood chip(s), wood shaving(s), wood cube(s) and/or wood piece(s) are then immediately able to commence the aging and/or flavoring process for the alcohol to be aged as soon as both the pre-soaked and flavored wood chip(s), wood shaving(s), wood cube(s) and/or wood piece(s) and the alcohol to be aged are added to the individual containers during the bottling process.

As used within the appended claims, the term “individual container” is intended to mean any type of bottle or container, was manufactured from glass, plastic, metal and/or some other type of material, in which the alcohol is packaged at the bottling facility and shipped for sale to a consumers. In addition, the term “wood particle”, as used within the appended claims, is intended to mean at least one of a thin piece of wood, a wooden dowel, wood chip(s), wood shaving(s), wood cube(s) and/or wood piece(s) or any other kind of wood which is designed to favor alcohol.

In the above description and appended drawings, it is to be appreciated that only the terms “consisting of” and “consisting only of” are to be construed in the limitative sense while of all other terms are to be construed as being open-ended and given the broadest possible meaning.

Since certain changes may be made in the above described improved process for continuing the aging of alcohol following bottling thereof, without departing from the spirit and scope of the invention herein involved, it is intended that all of the subject matter of the above description or shown in the accompanying drawings shall be interpreted merely as examples illustrating the inventive concept herein and shall not be construed as limiting the invention.

Wherefore, I/we claim:

1. A method of further aging of alcohol following bottling of the alcohol, the method comprising the steps of:
forming a mash and allowing the mash to ferment;
distilling the mash to form an alcohol concentrate;
storing the alcohol concentrate within a wooden container to commence barrel aging of the alcohol concentrate for a desired duration of time;
following the aging process, diluting the alcohol concentrate and bottling the diluted alcohol concentrate within an individual container; and
adding at least one wooden particle to an interior cavity of the individual container so that the diluted alcohol, once bottled within the individual container, can intimately mix with the at least one of wooden particle and continue the aging process of the alcohol following bottling of the diluted alcohol.

2. The method of further aging of alcohol, following bottling, according to claim 1, further comprising the step of providing the at least one wooden particle with a surface area of between about 36 cm² and 1680 cm² so as to continue the aging process following bottling of the alcohol.

3. The method of further aging of alcohol, following bottling, according to claim 1, further comprising the step of using at least one of wood chip(s), the wood shaving(s), wood cube(s) and the wood piece(s) as the at least one wooden particle.

4. The method of further aging of alcohol, following bottling, according to claim 3, further comprising the step of enclosing the wood chip(s), wood shaving(s), wood cube(s) and/or wood piece(s) within a permeable pouch which facilitates intimate contact between the alcohol the wood chip(s), wood shaving(s), wood cube(s) and/or wood piece(s).

5. The method of further aging of alcohol, following bottling, according to claim 4, further comprising the step of using cheese cloth as the permeable pouch which facilitates intimate contact between the alcohol the wood chip(s), wood shaving(s), wood cube(s) and/or wood piece(s).

6. The method of further aging of alcohol, following bottling, according to claim 4, further comprising the step of using at least one relatively thin piece of wood and at least one relatively thick piece of wood to continue the aging process following bottling of the diluted alcohol.

7. The method of further aging of alcohol, following bottling, according to claim 1, further comprising the step of enclosing at least one relatively thin piece of wood and at least one relatively thick piece of wood within a permeable pouch which facilitates intimate contact between the alcohol and the at least one relatively thin piece of wood and at least one relatively thick piece of wood.

8. The method of further aging of alcohol, following bottling, according to claim 1, further comprising the step of using a single elongate piece of wood as the at least one wooden particle which is added to the interior cavity of the individual container.

9. The method of further aging of alcohol, following bottling, according to claim 8, further comprising the step of providing the single elongate piece of wood with a length of between 2 and 8 inches, a width of between 4 and 15 inches and a thickness of between a few thousands of an inch and 1/16 and a surface area of between 36 cm² and 1680 cm².

10. The method of further aging of alcohol, following bottling, according to claim 1, further comprising the step of using wooden cubes as the at least one wood particle.

11. The method of further aging of alcohol, following bottling, according to claim 10, further comprising the step of adding between about 8 and about 25 wood cubes to the interior cavity of the individual container in which the plurality of pieces of wood have a combined surface area of between 36 cm² and 1680 cm².

12. The method of further aging of alcohol, following bottling, according to claim 1, further comprising the step of adding a sufficient amount of wood particles to the interior cavity of the individual container so that a ratio of a surface area of the wooden particles to the alcohol contained within the individual container is about 1:10.32.

13. The method of further aging of alcohol, following bottling, according to claim 1, further comprising the step of adding a sufficient amount of wood particles to the interior cavity of the individual container so that a ratio of a surface area of the wooden particles to the alcohol contained within the individual container is less than 1:10.32.

14. The method of further aging of alcohol, following bottling, according to claim 1, further comprising the step of adding a sufficient amount of wood particles to the interior cavity of the individual container so that a ratio of a surface area of the wooden particles to the alcohol contained within the individual container greater than 1:10.32.

15. The method of further aging of alcohol, following bottling, according to claim 1, further comprising the step of adding a sufficient amount of wood particles to the interior cavity of the individual container so that a ratio of a surface area of the at least one wooden particle to the alcohol contained within the individual container is about 1:5 or less.

16. The method of further aging of alcohol, following bottling, according to claim 1, further comprising the step of pre-soaking the at least one wooden particle in one of a quantity of the diluted alcohol to be aged, alcohol to be aged, wine, port, brandy, flavoring and a flavor enhancer until the at least one wooden particle is sufficiently saturated and thereafter the pre-soaked at least one wooden particle is then able to immediately commence the aging process as soon as both the pre-soaked at least one wooden particle and the diluted alcohol are added to the individual container during the bottling process.

17. The method of further aging of alcohol, following bottling, according to claim 1, further comprising the step of pre-soaking the at least one wooden particle in one of a quantity of the diluted alcohol to be aged, alcohol to be aged, wine, port, brandy, flavoring and a flavor enhancer for a duration of time of between about one week to about two years.

18. The method of further aging of alcohol, following bottling, according to claim 1, further comprising the step of attaching one of a pouring spout, a strainer, and some other pouring device to an inlet of the individual container to prevent the at least one wooden particle from inadvertently flowing out of the individual container when a consumer is pouring a drink.

19. The method of further aging of alcohol, following bottling, according to claim 1, further comprising the step of using a relatively thin piece of wood as the at least one wooded particle which functions both as a product label and as well as a flavor enhancer for the alcohol.

20. The method of further aging of alcohol, following bottling, according to claim 1, further comprising a step of storing the individual container at a temperature between 35 and 70° F.
